(19) United States
(12) Patent Application Publication
(10) Pub. No.: US 2026/0109390 A1
(43) Pub. Date: Apr. 23, 2026

(54) ADAPTIVE ERGONOMIC STEERING COLUMN FOR COMMERCIAL VEHICLES

(71) Applicant: ZF Active Safety and Electronics US LLC, Livonia, MI (US)

(72) Inventor: Praful BARI, West Lafayette, IN (US)

(21) Appl. No.: 18/921,073

(22) Filed: Oct. 21, 2024

(51) Int. Cl. B62D 1/189; B62D 1/184

(52) U.S. Cl. CPC B62D 1/189; B62D 1/184

(57) ABSTRACT

A steering system of a commercial vehicle includes a mounting bracket that has a jacket tube disposed inside a fixed mounting tube, a bracket portion connected at a first end to a fluid cylinder, and a second end connected to a pivot part at a first point. The fixed mounting tube has friction flaps. The fluid cylinder has a first end fixed to the mounting bracket, and a second end connected to the pivot part at a second point. When a handle, connected to the fixed mounting tube, is rotated from the closed position to the open position, the friction flaps loosen and permit the mounting bracket to slide relative to the fixed mounting tube. Rotation of the handle also causes a relief valve of the fluid cylinder to open, permit the fluid cylinder to change its length, and permit the pivot part to pivot about the second point.

### BACKGROUND

Conventional steering columns of commercial vehicles have extremely limited flexibility. Tilt and telescopic adjustments of conventional steering columns of commercial vehicles are limited to fixed positions. Due to the lack of flexibility of the fixed positions, drivers of commercial vehicles are unable to customize the positions of the steering wheel of the commercial vehicle. This prevents different drivers of commercial vehicles to find optimal positions of the steering wheel for long drives. The lack of flexibility of the fixed positions of tilt and telescopic movement also limits the number of drivers that may comfortably drive a particular commercial vehicle. In order to introduce more flexibility in steering columns of commercial vehicles, large scale redesign of the driving cabs of commercial vehicles may need to be performed.

### SUMMARY

Embodiments of the present disclosure provide, in a first aspect, a steering system of a commercial vehicle, the steering system comprising: a pivot part, having a first connection point and a second connection point; a mounting bracket, having a jacket tube disposed inside a fixed mounting tube, a bracket portion connected at a first end to a fluid cylinder, and a second end pivotably connected to the pivot part at the first connection point; the fixed mounting tube configured to receive the jacket tube of the mounting bracket, the fixed mounting tube having a first friction flap, a first external flange bracket for receiving a bolt, and a second friction flap having a second external flange bracket for receiving a nut; the fluid cylinder having a first end fixed to the mounting bracket, a second end pivotably connected to the pivot part at the second connection point, and a relief valve; a handle rotatably connected to the fixed mounting tube via a bolt, and movable between a closed position and an open position, wherein when the handle is rotated from the closed position to the open position, the bolt rotates relative to the nut so as to permit the first and second friction flaps to loosen and thereby permit the mounting bracket to slide relative to the fixed mounting tube and to permit telescopic movement of a steering column, and wherein rotation of the handle from the closed position to the open position causes the relief valve of the fluid cylinder to open via a steel strand, and permits the fluid cylinder to change its length and thereby to permits the pivot part to pivot about the second connection point.

According to an implementation of the first aspect, when the handle is rotated from the open position to the closed position, the bolt rotates relative to the nut so as to permit the first and second friction flaps to tighten and thereby prevents the mounting bracket from sliding relative to the fixed mounting tube and locks a telescopic position of the steering column.

According to an implementation of the first aspect, rotation of the handle from the open position to the closed position causes the relief valve of the fluid cylinder to close via the steel strand, and prevents the fluid cylinder from changing its length and thereby locks a position of the pivot part about the second connection point.

According to an implementation of the first aspect, the second external flange bracket is disposed vertically below the first external flange bracket, and wherein a first portion of a head end of the bolt is disposed above the first flange bracket, a second portion of the head end of the bolt is disposed inside the first flange bracket, and a portion of a tail end of the bolt is disposed inside the nut disposed in the second flange bracket.

According to an implementation of the first aspect, the handle further comprises: a positioning bracket having the closed position and the open position; and a handle lever comprising a grip, a magnetic end, and a pivot end, wherein the magnetic end is moveable between the closed position and the open position, and wherein the pivot end comprises a through hole.

According to an implementation of the first aspect, a support bracket is disposed vertically above the first flange bracket and below the through hole of the handle.

According to an implementation of the first aspect, a pivot bolt is inserted through the through hole of the handle and the support bracket, and wherein a tail end of the pivot bolt engages with the first portion of the head end of the bolt disposed above the first flange bracket.

According to an implementation of the first aspect, the rotation of the handle from the closed position to the open position causes the pivot bolt to partially rotate in an anti-clockwise direction, and wherein the rotation of the pivot bolt in the anti-clockwise direction causes the bolt to partially rotate in the anti-clockwise direction.

According to an implementation of the first aspect, the rotation of the bolt in the anti-clockwise direction causes the bolt to partially rotate out of the nut so as to permit the first and second friction flaps to loosen and thereby permit the mounting bracket to slide relative to the fixed mounting tube and to permit telescopic movement of the steering column.

According to an implementation of the first aspect, the rotation of the handle from the open position to the closed position causes the pivot bolt to partially rotate in a clockwise direction, and wherein the rotation of the pivot bolt in the clockwise direction causes the bolt to rotate in the clockwise direction.

According to an implementation of the first aspect, the rotation of the bolt in the clockwise direction causes the bolt to partially rotate into the nut so as to permit the first and second friction flaps to tighten and thereby prevent the mounting bracket from sliding relative to the fixed mounting tube and to lock a telescopic position of the steering column.

According to an implementation of the first aspect, a first end of the steel strand is connected to the handle and a second end of the steel strand is connected to the relief valve, and wherein the steel strand is contained within a cable sleeve.

According to an implementation of the first aspect, the fluid cylinder further comprises a piston that is coupled at the first end to the mounting bracket, and wherein the fluid cylinder and the piston are configured to slide relative to one another.

According to an implementation of the first aspect, when the relief valve is opened via the steel strand, the piston and the fluid cylinder move relative to one another, and wherein the relative motion between the piston and the fluid cylinder causes the pivot part to pivot about the second connection point.

Embodiments of the present disclosure provide, in a second aspect, a method of installing a new steering system of a commercial vehicle, the method comprising: removing an existing steering system of the commercial vehicle; and installing the new steering system in the commercial vehicle, the new steering system comprising: a pivot part, having a first connection point and a second connection point; a mounting bracket, having a jacket tube disposed inside a fixed mounting tube, a bracket portion connected at a first end to a fluid cylinder, and a second end pivotably connected to the pivot part at the first connection point; the fixed mounting tube configured to receive the jacket tube of the mounting bracket, the fixed mounting tube having a first friction flap, a first external flange bracket for receiving a bolt, and a second friction flap having a second external flange bracket for receiving a nut; the fluid cylinder having a first end fixed to the mounting bracket, a second end pivotably connected to the pivot part at the second connection point, and a relief valve; a handle rotatably connected to the fixed mounting tube via a bolt, and movable between a closed position and an open position, wherein when the handle is rotated from the closed position to the open position, the bolt rotates relative to the nut so as to permit the first and second friction flaps to loosen and thereby permit the mounting bracket to slide relative to the fixed mounting tube and to permit telescopic movement of a steering column, and wherein rotation of the handle from the closed position to the open position causes the relief valve of the fluid cylinder to open via a steel strand, and permits the fluid cylinder to change its length and thereby to permits the pivot part to pivot about the second connection point.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates a vertical perspective view of a steering column of a commercial vehicle, according to one or more examples of the present disclosure;

FIG. 2 illustrates a mounting bracket and a portion of the steering column of the commercial vehicle, according to one or more examples of the present disclosure;

FIG. 3 illustrates the fixed mounting tube of the steering column of the commercial vehicle, according to one or more examples of the present disclosure;

FIG. 4 illustrates a portion of a handle assembly of the steering column of the commercial vehicle, according to one or more examples of the present disclosure;

FIG. 5 illustrates a cross-section of the nut and bolt assembly associated with the fixed mounting tube of the steering column of the commercial vehicle, according to one or more examples of the present disclosure;

FIG. 6 illustrates operation of the friction flaps of the fixed mounting tube of the steering column of the commercial vehicle, according to one or more examples of the present disclosure;

FIG. 7 illustrates a spring locking mechanism of the steering column of the commercial vehicle, according to one or more examples of the present disclosure;

FIG. 8 illustrates a handle assembly of the steering column of the commercial vehicle, according to one or more examples of the present disclosure; and

FIG. 9 illustrates operation of the handle to perform adjustments of the steering column of the commercial vehicle, according to one or more examples of the present disclosure.

### DETAILED DESCRIPTION

Examples of the presented application will now be described more fully hereinafter with reference to the accompanying FIGS., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

Traditional steering columns of commercial vehicles are often fixed and only have limited adjustability options. Adjustments of traditional steering columns may only be restricted to fixed adjustments. The fixed adjustments of the steering column restrict the customizability of the steering columns for drivers of commercial vehicles. Different drivers of commercial vehicles are prevented from finding optimal positions of the steering column for long drives. This leads to suboptimal driver comfort and vehicle customization.

Introducing flexibility in steering columns of commercial vehicles may need cumbersome modifications of the driver cab, or the steering assembly which drastically limits vehicle customization. These limitations not only impact driver satisfaction but also increase maintenance complexity for fleet operators of commercial vehicles.

The present disclosure describes a design for a new steering column that introduces independent tilt and telescopic adjustments. Unlike traditional columns with fixed adjustment positions, the design of the new steering column presented herein offers an infinite range of tilt and telescopic adjustments, within safe limits. This allows drivers to find optimal driving positions easily. The design of the new steering column is highly customizable as the new steering columns may be designed to meet customer specific requirements. Drivers are able to adjust height, angle, and/or reach of steering wheels associated with the new steering column.

In some embodiments, the new steering column provides simultaneous telescopic and tilt adjustments of the steering column using a single handle. The simultaneous telescopic and tilt adjustments of the steering column facilitate ideal position of the steering wheel for the drivers of commercial vehicles.

The new steering column is designed to seamlessly replace traditional steering columns of commercial vehicles. The new steering column integrates into existing setups of cabs of commercial vehicles, without extensive retrofitting efforts. For example, the new steering column provides the flexibility of a steering column without a massive redesign of the cabs of commercial vehicles. The new steering column design provides safety features, such as automatic locking and collision avoidance during adjustments, ensuring safe operation of the commercial vehicles.

The new steering column design prioritizes robustness and reliability, thereby increasing safety and security of drivers of commercial vehicles.

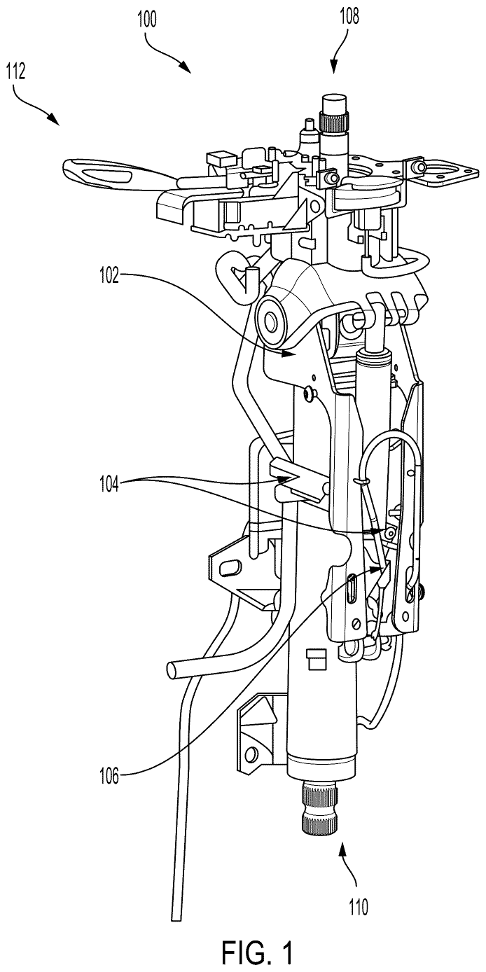

FIG. 1 illustrates a vertical perspective view of a steering column of a commercial vehicle, according to one or more examples of the present disclosure. Vertical perspective view 100 of FIG. 1 depicts a steering column 112. The steering column 112 includes a first end 108 and a second end 110. In some embodiments, the first end 108 connects to a steering wheel assembly of the commercial vehicle. In some embodiments, the second end 110 connects to a steering gear of a commercial vehicle. Steering commands received from a user at the steering wheel assembly are transmitted via the steering column to the steering gear, which steers the wheel assembly in the appropriate direction.

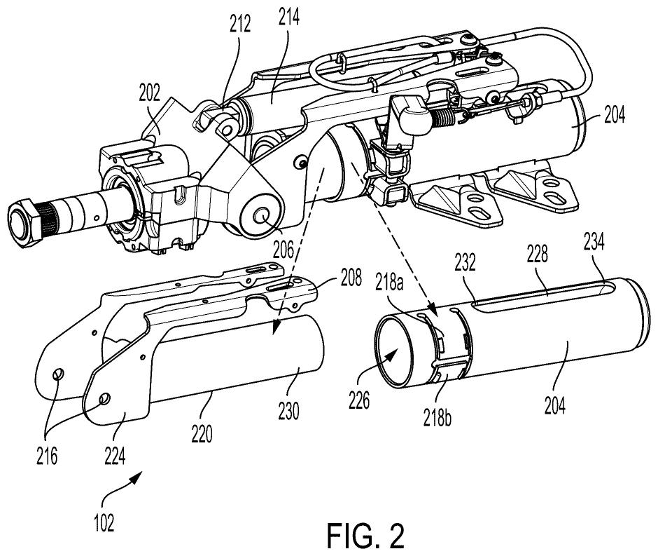

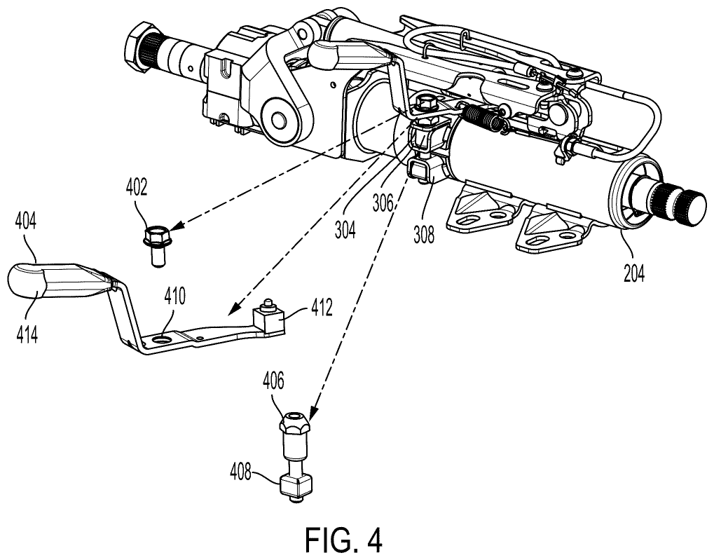

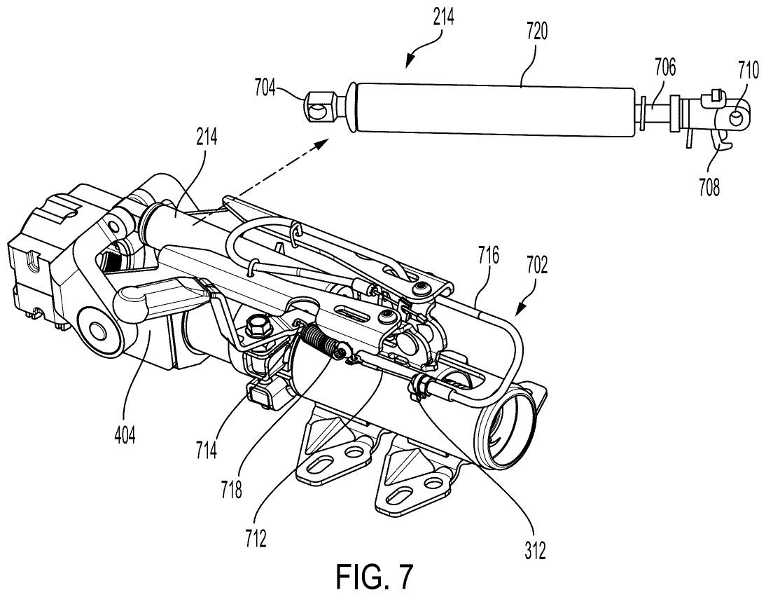

The steering column 112 includes a mounting bracket 102, a handle assembly 104, and a spring locking mechanism 106. The mounting bracket 112 as discussed in more detail in FIG. 2 provides independent telescopic adjustments of the steering column 112. The spring locking mechanism, discussed in more detail with respect to FIG. 7, provides independent tilt adjustments of the steering column 112. The handle assembly 104, discussed in more detail in FIGS. 4-6 controls the independent tilt and telescopic adjustments of the steering column 112. In some embodiments, the independent tilt and telescopic movements of the steering column 112 provides for a movement of the steering wheel assembly associated with the first end 108 of the steering column 112.

The modular design of the steering column 112 allows the new steering column 112 to replace existing steering columns in currently operating commercial vehicles, without a need for extensive redesigning of the driver cabs or remaining components of the steering assemblies of commercial vehicle.

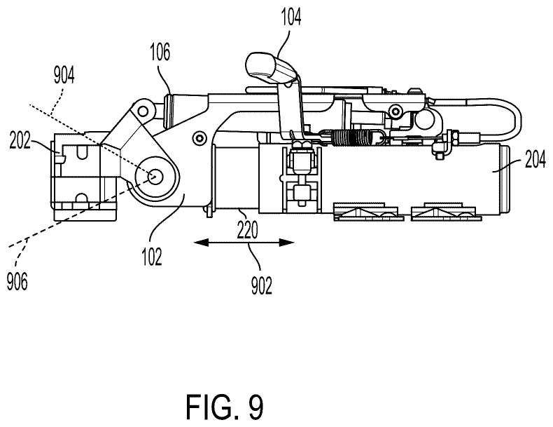

FIG. 2 illustrates a mounting bracket and a portion of the steering column of the commercial vehicle, according to one or more examples of the present disclosure. FIG. 2 provides a detailed view of the mounting bracket 102. The mounting bracket 102 includes a movable jacket tube 220. A top end 224 of the mounting bracket 102 includes holes 216 on opposite sides of the top portion. The holes 216 are used to fasten the top end 224 of the mounting bracket 102 to a connection point 206 of a pivot part 202. For example, a nut and bolt combination may be used to connect the top end 224 of the mounting bracket 102 to the connection point 206 of the pivot part 102. In some embodiments, the pivot part 202 may be configured to rotate around an axis running through the connection point 206. The rotation of the pivot part 202 around the axis running through the connection point 206 is described in more detail with respect to FIG. 9.

Upper flanges 208 are attached to the top end of the mounting bracket 102. The upper flanges 208 of the mounting bracket 102 are used to fixedly couple a bottom end of a gas spring 214 to the mounting bracket 102. A top end of the gas spring 214 is coupled to a second connection point 212 of the pivot part 202. In some embodiments, the top end of the gas spring 214 is coupled to the second connection point 212 of the pivot part using fasteners. For example, a nut and bolt combination may be used to connect the top end of the gas spring 214 to the second connection point 212 of the pivot part 102. In some cases, the pivot part 202 may rotate around the axis running through the connection point 206 based on a piston of the fluid tube of the gas spring being allowed to move freely in and out of the fluid tube of the gas spring. This is discussed in more detail with respect to FIGS. 7-9. The rotation of the pivot part 202 around the axis running through the connection point 206 is described in more detail with respect to FIG. 9.

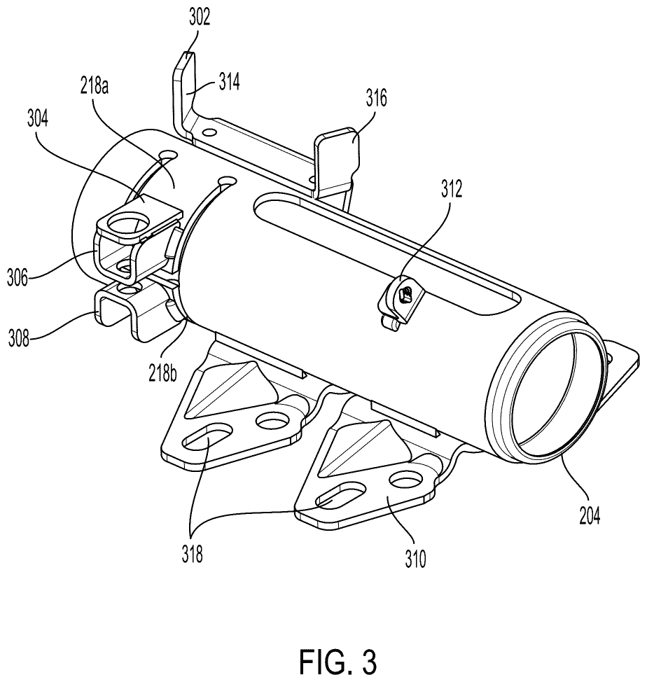

A bottom end of the jacket tube 220 of the mounting bracket 102 is inserted into a cavity 226 of the fixed mounting tube 204 of the steering column 112. The jacket tube 220 of the mounting bracket 102 slides in and out of the cavity 226 of the fixed mounting tube 204 of the steering column 112. The movement of the jacket tube 220 provides telescopic adjustments of the steering column 112. The fixed mounting tube 204 includes friction flaps 218a and 218b that are used to restrict the movement of the jacket tube 220 of the mounting bracket 102. In some embodiments, the friction flaps 218a and 218b form a portion of the fixed mounting tube 204. The restriction of the movement of the jacket tube 220 is used to lock a telescopic position of the steering column 112. The mechanism to restrict the jacket tube 220 of the mounting bracket 102 is discussed in more detail in FIGS. 3-6.

The fixed mounting tube 204 also includes an opening 228 disposed on a convex outer surface of the fixed mounting tube 204. The opening 228 disposed on the convex outer surface of the fixed mounting tube 204 creates space for the upper flanges 208 of the mounting bracket 102 to be mechanically coupled to a bottom portion 230 of the jacket tube 220 of the mounting bracket 102. The connection between the upper flanges 208 and the bottom portion 230 of the jacket tube 220 of the mounting bracket 102, through the opening 228 on the convex outer surface of the fixed mounting tube 204, limits the motion of the jacket tube 220 of the mounting bracket 102 within the fixed mounting tube 204.

In some embodiments, the length of the opening 228 on the convex outer surface of the fixed mounting tube 204 may be based on a range of telescopic adjustments to be provided to the steering column 112. A first end 232 of the opening 228 on the convex outer surface of the fixed mounting tube 204 provides a limit as to how far the jacket tube 220 of the mounting bracket 102 may be pulled outside the fixed mounting tube 204. A second end 234 of the opening 228 on the convex outer surface of the fixed mounting tube 204 provides a limit as to how far the jacket tube 220 of the mounting bracket 102 is pushed inside the fixed mounting tube 204. The position of the jacket tube 220 of the mounting bracket 102 may be fixed at any point between the first end 232 and the second end 234 of the opening on the convex outer surface of the fixed mounting tube 204. In case the length of the opening 228 is increased, the range of telescopic adjustments available to the steering column 112 is greater. Similarly, if the length of the opening 228 is decreased, the range of telescopic adjustments to the steering column 112 is lesser.

Additionally, the bottom portion of the gas spring 214 to be coupled to the upper flanges 208 of the mounting bracket 202. As the jacket tube 220 of the mounting bracket 102 slides in and out of the fixed mounting tube 204, the mounting bracket 102 moves towards and away from the fixed mounting tube 204. The gas spring 214 and the pivot part 202 are mechanically coupled to the mounting bracket 102, and so the gas spring 214 and the pivot part 202 move simultaneously with the mounting bracket 102 as a single unit.

FIG. 3 illustrates the fixed mounting tube of the steering column of the commercial vehicle, according to one or more examples of the present disclosure. The fixed mounting tube 204 as shown in FIG. 3 includes a plurality of elements welded to the convex outer surface of the fixed mounting tube 204. An acme support plate 304 and a first flange bracket 306 are welded to the first friction flap 218a, which forms a portion of the convex outer surface of the fixed mounting tube 204. The acme support plate 304 includes a through-hole to receive a bolt. The acme support plate is welded horizontally along the length of the first friction flap 218a. The first flange bracket 306 includes a through-hole to receive a thread end of a bolt. The first flange bracket is positioned immediately below the acme support plate 304 on the first friction flap 218a.

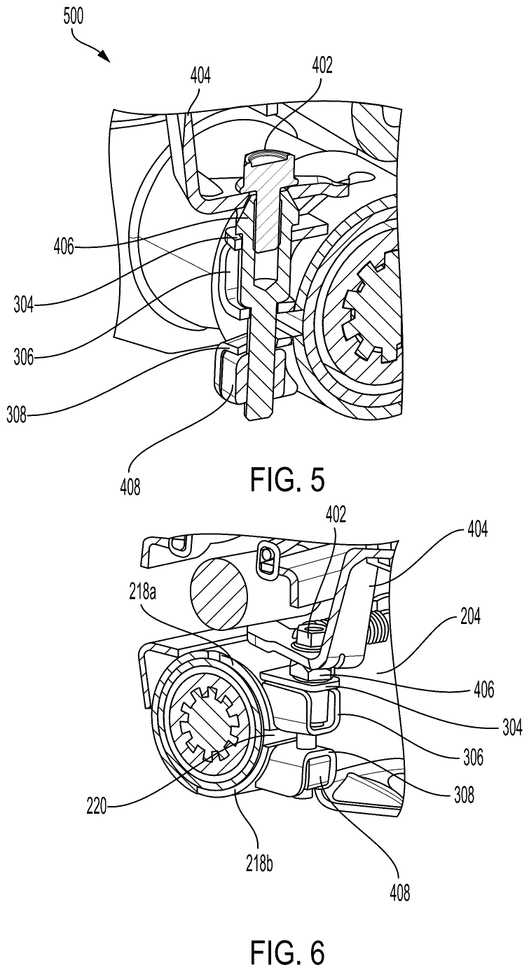

A second flange bracket 308 is welded to the second friction flap 218b, which forms a portion of the convex outer surface of the fixed mounting tube 204. The second flange bracket 308 is positioned below the first flange bracket 306. The second flange bracket 308 includes a through-hole. An upper side of the through-hole, that faces the first flange bracket 306, is positioned to receive the thread end of the bolt that is inserted through the through-hole of the first flange bracket 306. A lower side of the through-hole, which faces away from the first flange bracket 306, is configured to house a nut. The nut is held fixed in the second flange bracket 308. The thread end of the bolt from the first flange bracket 306, which is received in the through-hole of the second flange bracket 308, engages with the threads of the bolt housed in the second flange bracket 308. In some embodiments, the bolt may be allowed to spin freely on the nut. The operation of the nut and bolt is described in more detail in FIGS. 5 and 6.

In some embodiments, a distance between the first flange bracket 306 and the second flange bracket 308 is based on a length of the thread end of the bolt that is inserted through the through-hole of the first flange bracket 306. For example, the distance between the first flange bracket 306 and the second flange bracket 308 may be configured such that threads of the thread end of the bolt, which is inserted through the first flange bracket 306, engage with corresponding threads of the nut that is housed in the second flange bracket 308.

A handle bracket 302 is also welded on the convex outer surface of the fixed mounting bracket 204. In some embodiments, the handle bracket 302 is positioned on a portion of the convex outer surface of the fixed mounting tube 204 that is opposite to the friction flaps 218a and 218b. The handle bracket 302 has a first end 314 and a second end 316. The first end 314 and the second end 316 limit the motion of the handle as it moves from an open position to a closed position, or vice versa. For example, a first end 314 of the handle bracket 302 may correspond to an open position of the handle and a second end 316 of the handle bracket may correspond to a closed position of the handle. In the open position, the handle may unlock the telescopic and tilt adjustments of the steering column 112, and in the closed position, the handle may lock the position of the steering column 112.

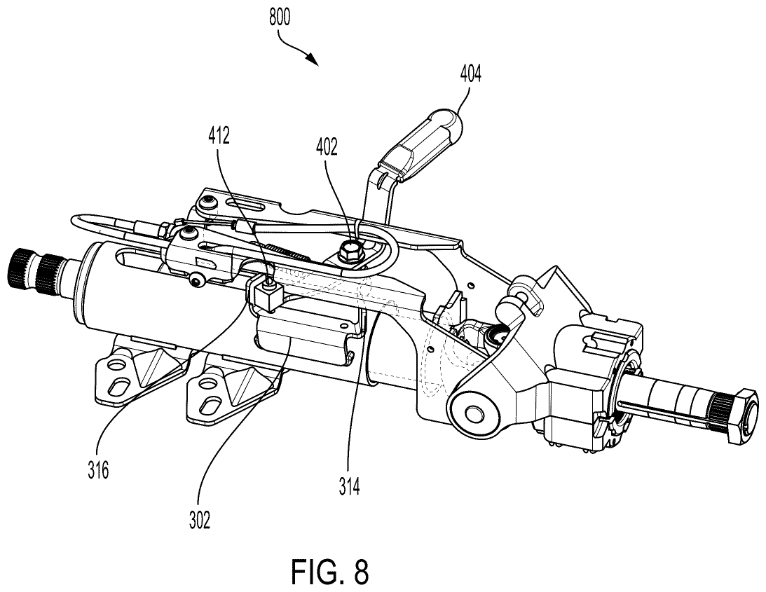

Cable bracket 312 is also welded to a convex outer surface of the fixed mounting tube 204. The cable bracket 312 is positioned to receive a cable assembly associated with the gas spring 214 (as shown in FIG. 2). The operation of the gas spring 214 and the operation of the cable assembly is described in more detail in FIGS. 7 and 8.

A support bracket 310 is used to support the fixed mounting tube 204. In some embodiments, the support bracket 312 may include a curved portion with a concave surface. In some embodiments, the concave surface of the curved portion of the support bracket 310 may be placed adjacent to the convex outer portion of the fixed mounting tube 204. For example, a curvature of the concave surface of the curved portion of the support bracket 310 matches a curvature of the convex outer surface of the fixed mounting tube 204. The support bracket 310 may be held in place by using a plurality of bolts. The plurality of bolts may be used to securely fasten the support bracket 310 to a chassis of the commercial vehicle. For example, the support bracket 310 may include a plurality of through-holes 318 that align with corresponding holes in the chassis of the commercial vehicle. The plurality of the bolts may be inserted through the through-holes 318 of the support bracket 102 and the corresponding holes of the chassis to hold the support bracket 310 in place.

FIG. 4 illustrates a portion of a handle assembly of the steering column of the commercial vehicle, according to one or more examples of the present disclosure. FIG. 4 depicts a bolt 402, a handle 404, an acme right hand bolt 406, and an acme right hand nut 408. Motion of a handle from a closed position to an open position increases a distance between the flange brackets 306 and 308 to loosen the friction flaps 218a and 218b (as shown in FIG. 3). The loosened friction flaps 218a and 218b allow the jacket tube 220 of the mounting bracket 102 to freely move in and out of the fixed mounting tube 204. The bolt 402, acme right hand bolt 406, and acme right hand nut 408 may be used to mechanically couple the handle 404 to the flange brackets 306 and 308.

The handle 404 includes a grip 414, a through-hole 410 and a magnetic end 412. The grip 414 may be used by a driver to move the handle 404 between an unlock position and a lock position. At the unlock position of the handle 404, the steering column 112 is free to move within a permitted range. At the lock position, the position of the steering column 112 locked securely. The handle 404 is positioned above the acme support plate 304.

The bolt 402 of FIG. 4 may be a 5/16-18×0.625″ bolt. A thread end of the bolt 402 is inserted through the through-hole 410 of the handle 404.

The acme right hand bolt 406 is inserted through the through-hole of the acme support plate 304. A first part of the head portion of the acme right hand bolt 406 remains above the acme support plate 304, and below the handle 404. The thread end of the bolt 402 engages with the first part of the head portion of the acme right hand bolt 406 that is present between the handle 404 and the acme support plate 304.

A second part of the head portion of the acme right hand bolt 406 is housed within the first flange bracket 306. A thread end of the acme right hand bolt 406 bolt is inserted through the second flange bracket 306.

The acme right hand nut 408 is housed within the second flange bracket 308. The threads on the thread end of the acme right hand bolt 406 engage with corresponding threads in the acme right hand nut 408. The acme right hand bolt 406 is configured to spin freely through the acme right hand nut 408.

FIG. 5 illustrates a cross-section of the nut and bolt assembly associated with the fixed mounting tube of the steering column of the commercial vehicle, according to one or more examples of the present disclosure. FIG. 5 depicts a cross-section view 500 that includes a cross-section view of the bolt 402, acme support plate 304, acme right hand bolt 406, first flange bracket 306, acme right hand nut 408, and second flange bracket 308.

A thread end of the bolt 402 is inserted through the through-hole 410 of the handle 404.

The acme right hand bolt 406 is inserted through the through-hole of the acme support plate 304. A first part of the head portion of the acme right hand bolt 406 remains above the acme support plate 304, and below the handle 404. The thread end of the bolt 402 engages with the first part of the head portion of the acme right hand bolt 406 that is present between the handle 404 and the acme support plate 304.

A second part of the head portion of the acme right hand bolt 406 is housed within the first flange bracket 306. A thread end of the acme right hand bolt 406 is inserted through the second flange bracket 306.

The acme right hand nut 408 is housed within the second flange bracket 308. The threads on the thread end of the acme right hand bolt 406 engage with corresponding threads in the acme right hand nut 408. The acme right hand bolt 406 is configured to spin freely through the acme right hand nut 408.

FIG. 6 illustrates operation of the friction flaps of the fixed mounting tube of the steering column of the commercial vehicle, according to one or more examples of the present disclosure. FIG. 6 depicts a close up view of the handle 404, the acme support plate 304, the first flange bracket 306, the and second flange bracket 308. The operation of the handle 404 modifies the distance between the friction flaps 218a and 218b of the fixed mounting tube 204 (as shown in FIG. 4). As described above with respect to FIG. 3, the handle 404 is configured to move from a closed position to an open position and vice versa.

Motion of the handle 404 from a closed position to an open position causes the bolt 402 to rotate in an anti-clockwise direction. The rotation of the bolt 402 in the anti-clockwise direction causes the acme right hand bolt 406 to rotate in the anti-clockwise direction because the thread end of the bolt 402 engages with the first portion of the head of the acme right hand bolt 406. The rotation of the acme right hand bolt in the anti-clockwise direction causes the acme right hand bolt 406 to lift out of the acme right hand nut 408. In some embodiments, the threads of the acme right hand bolt 406 engage with corresponding threads in the acme right hand nut 408. The acme right hand nut 408 is held fixed with respect to the acme right hand bolt 406 in the second flange bracket 308. Thus, the acme right hand bolt 406 is able to spin freely with respect to the acme right hand nut 408. The anti-clockwise motion of the acme right hand bolt 406, caused by the anti-clockwise motion of the bolt 402, causes the acme right hand bolt 406 to spin away from the acme right hand nut 408. The movement of the acme right hand bolt 406 away from the acme right hand nut 408 increases a distance between the flange brackets 306 and 308. The increase in distance between the first flange bracket 306 and the second flange bracket 308 loosens the friction flaps 218a and 218b (as shown in FIG. 3). The loosened friction flaps 218a and 218b creates a slip fit between the jacket tube 220 of the mounting bracket 102 and the fixed mounting tube 204. The slip fit allows the jacket tube 220 of the mounting bracket 102 to freely move in and out of the fixed mounting tube 204. The movement of the jacket tube 220 in and out of the fixed mounting tube 204 allows for telescopic adjustment of the steering column 112.

On the other hand, motion of the handle 404 from the open position to the closed position causes the bolt 402 to rotate in a clockwise direction. The rotation of the bolt 402 in the clockwise direction causes the acme right hand bolt 406 to rotate in the clockwise direction because the thread end of the bolt 402 engage with the first portion of the head of the acme right hand bolt 406. The rotation of the acme right hand bolt in the clockwise direction causes the acme right hand bolt 406 to screw into the acme right hand nut 408. In some embodiments, the threads of the acme right hand bolt 406 engages with corresponding threads in the acme right hand nut 408. The acme right hand nut 408 is held fixed with respect to the acme right hand bolt 406 in the second flange bracket 308. Thus, the acme right hand bolt 406 is able to spin freely with respect to the acme right hand nut 408. The clockwise motion of the acme right hand bolt 406, caused by the clockwise motion of the bolt 402, causes the acme right hand bolt 406 to spin towards the acme right hand nut 408. The movement of the acme right hand bolt 406 towards the acme right hand nut 408 decreases the distance between the flange brackets 306 and 308. The decrease in distance between the first flange bracket 306 and the second flange bracket 308 tightens the friction flaps 218a and 218b (as shown in FIG. 3). The tightened friction flaps 218a and 218b creates an interference fit between the jacket tube 220 of the mounting bracket 102 and the fixed mounting tube 204. The interference fit locks the position of the jacket tube 220 and prevents the jacket tube 220 of the mounting bracket 102 from freely moving in and out of the fixed mounting tube 204. The locked position of the jacket tube 220 limits the telescopic movement of the steering column 112.

FIG. 7 illustrates a spring locking mechanism of the steering column of the commercial vehicle, according to one or more examples of the present disclosure. The spring locking mechanism 106 is introduced in FIG. 1. The spring locking mechanism includes a gas spring 214. Gas spring 214 has a fluid tube 720 and a piston 706, which may be configured to move in and out of the fluid tube 720. The gas spring 214 includes a top fastening hook 704 at a top end of the gas spring 214. The top fastening hook 704 may be used to couple the gas spring 214 to the second connection point 212 of the pivot part 202. A bottom end of the gas spring 214 includes a bottom fastening hook 710. The bottom fastening hook 710 may be used to mechanically couple the gas spring 214 to the upper flanges 208 of the mounting bracket 102 (as shown in FIG. 2 in more detail). As the gas spring is coupled to the pivot part 202 and the mounting bracket 102, the gas spring 214 moves with the mounting bracket 102 as one combined unit.

A piston 706 is inserted through a bottom portion of the gas spring 214. The piston 706 may be used to modify the length of the gas spring 214. A relief valve 708, connected to the piston 706 controls the operation of the piston 706. The relief valve 708 may be connected to a cable assembly 702. The cable assembly 702 may be divided into a first portion 716 and a second portion 712. A first end of the first portion 716 of the cable assembly 702 may be connected to the relief valve 708, and a second end of the first portion 716 of the cable assembly 702 may be connected to the cable bracket 312, that is welded into the convex outer surface of the fixed mounting tube 204. A first end of the second portion 712 of the cable assembly may be connected to the cable bracket 702. A second end of the second portion 712 of the cable assembly 312 may be connected to the handle 404 at connection point 714 via a spring 718. The cable assembly 312 may include a steel strand covered with a sleeve. As the handle 404 may be moved from the closed position to the open position, the connection point 714 moves in an upwards direction which permits the spring 718 to stretch. The stretching of the spring 718 pulls the steel strand of the cable assembly 702. The pulling of the steel strand of the cable assembly 702 may rotate the relief valve 708 from a closed position to an open position. When the relief valve 708 is in the open position, the piston rod 706 is free to move in and out relative to the fluid tube 720.

As the handle 404 may be moved from the open position to the closed position, the connection point 714 moves in a downwards direction which permits the spring 718 to contract. The contraction of the spring 718 pushes the steel strand of the cable assembly 702. The pushing of the steel strand of the cable assembly 702 may rotate the relief valve 708 from the open position to the closed position. When the relief valve 708 is in the closed position, the position of the piston rod 706 is locked with respect to the fluid tube 720.

FIG. 8 illustrates a handle assembly of the steering column of the commercial vehicle, according to one or more examples of the present disclosure. The handle mechanism 104 is introduced in FIG. 1. The handle mechanism 104 includes a handle 404 and a handle bracket 302. The handle 404 includes a grip 414, a magnetic end 412 and a through-hole. A bolt 402 is inserted through the through-hole of the handle 404. As described in FIG. 4, the thread end of the bolt 402 engages with the first part of the head portion of the acme right hand bolt 406 that is present between the handle 404 and the acme support plate 304. The handle 404 is configured to rotate around the bolt 402.

As described with respect to FIG. 4, the handle bracket 302 is positioned on a portion of the convex outer surface of the fixed mounting tube 204 that is opposite to the friction flaps 218a and 218b. The first end 314 of the handle bracket 302 corresponds to an open position and the second end 316 of the handle bracket 302 corresponds to a closed position.

The magnetic end 412 of the handle 404 includes a magnet. The magnet of the magnetic end 412 may be used to secure a position of the handle 404 in a locked position, at the second end 316, or an unlocked position, at the first end 314.

FIG. 9 illustrates operation of the handle to perform adjustments of the steering column of the commercial vehicle, according to one or more examples of the present disclosure. As described with respect to FIG. 8, the handle 404 of the handle mechanism 404 may be moved from a closed position to an open position. As described with respect to FIG. 8, once the handle is moved from the closed position to the open position, adjustments may be made to the telescopic and tilt positions of the steering column 112.

Motion of the handle 404 from a closed position to an open position increases a distance between the flange brackets 306 and 308 to loosen the friction flaps 218a and 218b (as shown in FIG. 3). The loosened friction flaps 218a and 218b allow the jacket tube 220 (as shown in FIG. 3) of the mounting bracket 102 to freely move in and out of the fixed mounting tube 204 along the direction 902. The movement of the jacket tube 220 along the direction 902 provides telescopic adjustments of the steering column 112. The jacket tube 220 may be stopped at any point as it moves in and out of the fixed mounting bracket 204. The telescopic movements are described in more detail with respect to FIGS. 2-6.

Simultaneously, motion of the handle 404 from a closed position to an open position stretches the spring 718 of the cable assembly 702 (shown in FIG. 7), which in turn, pulls the steel strand of the cable assembly 702. The pulling of the steel strand of the cable assembly 702 rotates the relief valve 708 (shown in FIG. 7) from a closed position to an open position. When the relief valve 708 is in the open position, the piston rod 706 is free to move in and out of the fluid tube 720 of the gas spring 214 (shown in FIG. 2). In some embodiments, moving the relief valve from the closed position to the open position allows the piston rod 706 to move in and out of the fluid tube 720 freely. The movement of the piston rod 706 in and out of the fluid tube 720, may be used to rotate the pivot part 202. For example, the pivot part 202 is permitted to rotate around an axis of the connection point 206 of the pivot part 202 based on the movement of the piston rod 706 in and out of the fluid tube 720. The motion of the pivot part 202 around the axis of the connection point 202 is restricted between a first limit 904 and a second limit 906.

A driver of the commercial vehicle may align the steering column 112 of the commercial vehicle at a convenient position. Once the driver is comfortable, the driver may lock the position of the steering wheel by moving the handle 404 of the handle mechanism 104 from the open position to the closed position.

Upon moving the handle 404 from the open position to the closed position, the distance between the flange brackets 306 and 308 (as shown in FIG. 3) is decreased. The decrease in distance between the first flange bracket 306 and the second flange bracket 308 tightens the friction flaps 218a and 218b (as shown in FIG. 3). The tightened friction flaps 218a and 218b creates an interference fit between the jacket tube 220 of the mounting bracket 102 and the fixed mounting tube 204. The interference fit locks the position of the jacket tube 220 and prevents the jacket tube 220 of the mounting bracket 102 to freely move in and out of the fixed mounting tube 204. The locked position of the jacket tube 220 limits the telescopic movement of the steering column 112.

At the same time, as the handle 404 may be moved from the open position to the closed position, the connection point 714 (shown in FIG. 7) moves in a downwards direction which permits the spring 718 (shown in FIG. 7) to contract. The contraction of the spring 718 pushes the steel strand of the cable assembly 702(shown in FIG. 7). The pushing of the steel strand of the cable assembly 702 (shown in FIG. 7) may rotate the relief valve 708 (shown in FIG. 7) from the open position to the closed position. When the relief valve 708 is in the closed position, the position of the piston rod 706 is locked with respect to the fluid tube 720 (shown in FIG. 7). Once the position of the piston rod 706 is locked, the position of the pivot part 202 is locked at any point between the first limit 904 and the second limit 906.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A steering system of a commercial vehicle, the steering system comprising:
a pivot part, having a first connection point and a second connection point;
a mounting bracket, having a jacket tube disposed inside a fixed mounting tube, a bracket portion connected at a first end to a fluid cylinder, and a second end pivotably connected to the pivot part at the first connection point;
the fixed mounting tube configured to receive the jacket tube of the mounting bracket, the fixed mounting tube having a first friction flap, a first external flange bracket for receiving a bolt, and a second friction flap having a second external flange bracket for receiving a nut;
the fluid cylinder having a first end fixed to the mounting bracket, a second end pivotably connected to the pivot part at the second connection point, and a relief valve;
a handle rotatably connected to the fixed mounting tube via the bolt, and movable between a closed position and an open position,
wherein when the handle is rotated from the closed position to the open position, the bolt rotates relative to the nut so as to permit the first and second friction flaps to loosen and thereby permit the mounting bracket to slide relative to the fixed mounting tube and to permit telescopic movement of a steering column, and
wherein rotation of the handle from the closed position to the open position causes the relief valve of the fluid cylinder to open via a steel strand, and permits the fluid cylinder to change its length and thereby permits the pivot part to pivot about the first connection point.

2. The steering system of claim 1, wherein when the handle is rotated from the open position to the closed position, the bolt rotates relative to the nut so as to permit the first and second friction flaps to tighten and thereby prevents the mounting bracket from sliding relative to the fixed mounting tube and locks a telescopic position of the steering column.

3. The steering system of claim 1, wherein rotation of the handle from the open position to the closed position causes the relief valve of the fluid cylinder to close via the steel strand, and prevents the fluid cylinder from changing its length and thereby locks a position of the pivot part about the first connection point.

4. The steering system of claim 1, wherein the second external flange bracket is disposed vertically below the first external flange bracket, and wherein a first portion of a head end of the bolt is disposed above the first flange bracket, a second portion of the head end of the bolt is disposed inside the first flange bracket, and a portion of a tail end of the bolt is disposed inside the nut disposed in the second flange bracket.

5. The steering system of claim 4, further comprising:
a positioning bracket having the closed position and the open position; and
a handle lever comprising a grip, a magnetic end, and a pivot segment,
wherein the magnetic end is moveable between the closed position and the open position, and wherein the pivot segment comprises a through hole.

6. The steering system of claim 5, wherein a support bracket is disposed vertically above the first flange bracket and below the through hole of the handle.

7. The steering system of claim 6, wherein a pivot bolt is inserted through the through hole of the handle and the support bracket, and wherein a tail end of the pivot bolt engages with the first portion of the head end of the bolt disposed above the first flange bracket.

8. The steering system of claim 7, wherein the rotation of the handle from the closed position to the open position causes the pivot bolt to partially rotate in an anti-clockwise direction, and wherein the rotation of the pivot bolt in the anti-clockwise direction causes the bolt to partially rotate in the anti-clockwise direction.

9. The steering system of claim 8, wherein the rotation of the bolt in the anti-clockwise direction causes the bolt to partially rotate out of the nut so as to permit the first and second friction flaps to loosen and thereby permit the mounting bracket to slide relative to the fixed mounting tube and to permit telescopic movement of the steering column.

10. The steering system of claim 7, wherein the rotation of the handle from the open position to the closed position causes the pivot bolt to partially rotate in a clockwise direction, and wherein the rotation of the pivot bolt in the clockwise direction causes the bolt to rotate in the clockwise direction.

11. The steering system of claim 10, wherein the rotation of the bolt in the clockwise direction causes the bolt to partially rotate into the nut so as to permit the first and second friction flaps to tighten and thereby prevent the mounting bracket from sliding relative to the fixed mounting tube and to lock a telescopic position of the steering column.

12. The steering system of claim 1, wherein a first end of the steel strand is connected to the handle and a second end of the steel strand is connected to the relief valve, and wherein the steel strand is contained within a cable sleeve.

13. The steering system of claim 1, wherein the fluid cylinder further comprises a piston that is coupled at the second end to the mounting bracket, and wherein the fluid cylinder and the piston are configured to slide relative to one another.

14. The steering system of claim 13, wherein when the relief valve is opened via the steel strand, the piston and the fluid cylinder move relative to one another, and wherein the relative motion between the piston and the fluid cylinder causes the pivot part to pivot about the first connection point.

15. A method of installing a new steering system of a commercial vehicle, the method comprising:
removing an existing steering system of the commercial vehicle; and
installing the new steering system in the commercial vehicle, the new steering system comprising:
a pivot part, having a first connection point and a second connection point;
a mounting bracket, having a jacket tube disposed inside a fixed mounting tube, a bracket portion connected at a first end to a fluid cylinder, and a second end pivotably connected to the pivot part at the first connection point;
the fixed mounting tube configured to receive the jacket tube of the mounting bracket, the fixed mounting tube having a first friction flap, a first external flange bracket for receiving a bolt, and a second friction flap having a second external flange bracket for receiving a nut;
the fluid cylinder having a first end fixed to the mounting bracket, a second end pivotably connected to the pivot part at the second connection point, and a relief valve;
a handle rotatably connected to the fixed mounting tube via a bolt, and movable between a closed position and an open position,
wherein when the handle is rotated from the closed position to the open position, the bolt rotates relative to the nut so as to permit the first and second friction flaps to loosen and thereby permit the mounting bracket to slide relative to the fixed mounting tube and to permit telescopic movement of the steering column, and
wherein rotation of the handle from the closed position to the open position causes the relief valve of the fluid cylinder to open via a steel strand, and permit the fluid cylinder to change its length and thereby to permit the pivot part to pivot about the second connection point.
